(19) United States
(12) Patent Application Publication
(10) Pub. No.: US 2006/0120939 A1
(43) Pub. Date: Jun. 8, 2006

(54) Gas scrubbing method using electric energy and fossil fuel and gas scrubber thereof

(76) Inventor: Dong Soo Kim, Kyungki-do (KR)

Correspondence Address: DAFFER MCDANEIL LLP, P.O. BOX 684908, AUSTIN, TX, 78768, US

(21) Appl. No.: 11/146,590

(22) Filed: Jun. 7, 2005

(30) Foreign Application Priority Data
Dec. 8, 2004 (WO) PCT/KR04/03217

(51) Int. Cl. B01D 53/72; B01D 53/34; B01J 8/00

(52) U.S. Cl. 423/245.3; 422/168; 422/173; 422/174; 422/184.1

(57) ABSTRACT

The present invention relates to a burning type gas scrubbing method using an electrical energy and a fossil energy at the same time, and a gas scrubber implementing the method. The gas scrubber has a burning chamber, the burning chamber comprising an inner casing defining a burning room; at least a gas inlet for introducing the waste gas into the burning room; an air inlet for introducing air into the burning room; and an electrical heater disposed on an outer circumference of the burning room and connected to a power source through a power supply line. The burning room comprises an ignition fuel port for introducing an ignition fuel into the burning chamber when the temperature of the burning room rises above a predetermined temperature, an ignition sensor for a flame generated by injecting the ignition fuel, and a main fuel port for supplying a large amount of fuel when the ignition sensor senses an ignition flame. According to the gas scrubbing method and the gas scrubber of the present invention, the electrical energy and the fossil energy are used together, thereby enhancing the energy efficiency and the gas scrubbing efficiency at the same and decreasing the emission of CO₂ gas.

### PRIORITY APPLICATION

This application claims priority to application no. PCT/KR2004/003217 filed Dec. 8, 2004.

### BACKGROUND OF THE INVENTION

1. Field of the Invention

The present invention relates to a method and a gas scrubber for scrubbing waste gases including inflammable gases and toxic gases.

2. Description of the Related Art

In general, methods for scrubbing waste gases, inflammable gases and toxic gases are classified into a wetting method in which the waste gases are cleaned or cooled by water, a burning method in which the waste gases are burnt, and a mixed method in which the wetting method and the burning method are combined.

In particular, PFC (perfluorocompound) gas used in semiconductor manufacturing processes absorbs infrared ray, thereby causing global weather change and global warming effect. To suppress the emission of the PFC gas, among the burning type scrubbers, a direct burning type scrubber is in the limelight. This scrubber thermally decomposes the PFC gas using heat energy generated by burning of fuel such as LNG or LPG.

However, since the conventional direct burning type scrubber burns a large amount of fossil fuel such as LNG or LPG so as to scrub some PFC gases (CF₄, C₂F₆, etc.) that need a very high thermal energy, efficiency in scrubbing the gases is enhanced but energy efficiency is considerably lowered so that a lot of CO₂ gas is generated.

### SUMMARY OF THE INVENTION

Accordingly, the present invention is directed to a method for scrubbing waste gas and a gas scrubber that substantially obviate one or more problems due to limitations and disadvantages of the related art.

An object of the present invention is to provide a method for scrubbing waste gas and a gas scrubber that can enhance a waste gas scrubbing efficiency and an energy efficiency and decrease emission of CO₂ gas.

Another object of the present invention is to provide a gas scrubber that can prevent an inner portion of a burning chamber from being corroded.

A further object of the present invention is to provide a gas scrubber in which a waste gas introduced into a burning chamber is effectively mixed with a fuel.

Still another object of the present invention is to provide a gas scrubber which can reuse waste heat of a burning chamber to enhance the heat efficiency.

Yet another object of the present invention is to provide a gas scrubber that can continue to scrub a waste gas even when one gas scrubbing unit is stopped.

The above objects are achieved by the method and the gas scrubber for scrubbing a waste gas exhausted in a semiconductor manufacturing process according to the invention. The method being characterized in that both electrical energy and fossil energy are used and their usage rates are adjusted according to components contained in the gas and a scrubbing environment.

In another aspect of the present invention, the method for scrubbing a waste gas includes a burning stage, the stage comprising: raising temperature of the burning chamber to above a predetermined temperature by an electrical heater; when it is sensed that the temperature of the burning chamber is above the predetermined temperature, injecting a burning air and an ignition fuel to generate an ignition flame; and when the ignition flame is sensed, injecting a main fuel with the gas to generate a main flame and burn the gas.

In another aspect of the present invention, there is provided a gas scrubber with a burning chamber, the burning chamber comprising: an inner casing defining a burning room; at least a gas inlet for introducing the waste gas into the burning room; an air inlet for introducing air into the burning room; and an electrical heater disposed on an outer circumference of the burning room and connected to a power source through a power supply line. The burning room comprises: an ignition fuel port for introducing an ignition fuel into the burning chamber when the temperature of the burning room rises above a predetermined temperature, an ignition sensor for a flame generated by injecting the ignition fuel, and a main fuel port for supplying a large amount of fuel when the ignition sensor senses an ignition flame.

Preferably, the above gas scrubber may further comprise an adiabatic member disposed on an outer circumference of the electrical heater.

Also, an outer casing may be disposed outside the burning chamber, and a middle casing for dividing a space may be disposed between the outer casing and the inner casing. In that case, the electrical heater is disposed between the middle casing and the inner casing, and the adiabatic member is disposed between the outer casing and the middle casing.

Preferably, a main flame sensor for sensing flame when the main fuel is supplied may be disposed in the burning room.

Alternatively, the inner casing may be provided on an inner surface thereof with an anticorrosive jacket made of nickel.

In addition, the anticorrosive jacket may have at least one turbulence-forming wing formed at an upper portion thereof so as to accelerate a mixing the waste gas introduced with the fuel due to the turbulence, the turbulence-forming wing being formed by partially cutting away the anticorrosive jacket and bending the cutaway portion at a predetermined angle.

Preferably, the main fuel port may be connected to the gas inlet such that the waste gas is mixed with the fuel before being introduced into the burning room.

Also, the burning chamber is provided at an upper portion thereof with a heat exchange jacket such that the inner heat of the chamber is blocked not to be transmitted to an upper portion of the sensor, wherein air that has passed through the heat exchange jacket is transmitted to the air inlet.

The above scrubber may further comprise a gasket disposed between an upper end of the burning chamber and the heat exchange jacket.

Preferably, at least two scrubbers may be installed in a housing.

According to the method for scrubbing the waste gas, the energy efficiency and the gas scrubbing efficiency can be enhanced at the same time since the electrical energy and the fossil energy are used together in burning the waste gas.

The gas scrubber according to the present invention can enhance the gas scrubbing efficiency with a small amount of fuel and decrease the emission of CO₂ gas by using the burning chamber configured to enable a hybrid burning process.

In addition, the gas scrubber is provided on an inner surface of the inner casing with an exchangeable anticorrosive jacket made of nickel, thereby preventing the inside of the burning room from being corroded and extending the life cycle of the burning chamber.

Further, the gas scrubber can accelerate the mixing of the fuel and the waste gas since the fuel inlet is connected with the gas inlet and the turbulence-forming wing is formed inside the burning room, thereby enhancing the burning efficiency.

The heat exchange jacket disposed at an upper end of the burning chamber prevents heat from being leaked and reuses the waste heat, thereby enhancing the heat efficiency.

Also, according to the present invention, at least two gas scrubbers can be installed in one housing, so that gas scrubbing process can be continued even when one scrubber is stopped due to an operation failure.

It is to be understood that both the foregoing general description and the following detailed description of the present invention are exemplary and explanatory and are intended to provide further explanation of the invention as claimed.

Other objects, features and advantages of the present invention will be readily appreciated as the same becomes better understood after reading the subsequent description taken in connection with the accompanying drawings.

### BRIEF DESCRIPTION OF THE DRAWINGS

FIG. 1 is a flow chart schematically illustrating a burning stage in a method for scrubbing a waste gas according to an embodiment of the present invention;

FIG. 2 is a perspective view of a gas scrubber according to an embodiment of the present invention;

FIG. 3 is a partial cutaway perspective view of a burning chamber of the gas scrubber of FIG. 2;

FIG. 4 is a sectional view of the burning chamber of FIG. 3;

FIG. 5 is a plane view of the burning chamber of FIG. 3; and

FIG. 6 is a front view of a gas scrubber according to another embodiment of the present invention.

### DETAILED DESCRIPTION OF THE PREFERRED EMBODIMENTS

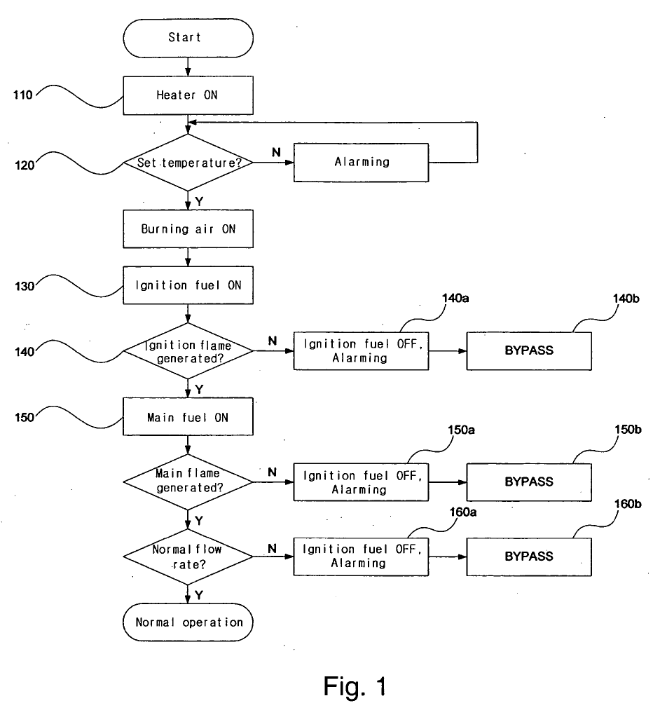

FIG. 1 is a flow chart schematically illustrating a burning stage in a method for scrubbing a waste gas according to an embodiment of the present invention. Referring to FIG. 1, in the burning operation of the method for scrubbing a waste gas, firstly a burning chamber is heated by an electrical heater at a step 110, then if the inner temperature of the heated burning chamber is above a set temperature at a step 120, burning air and ignition fuel are injected to generate an ignition flame at a step 130, then when the ignition flame is sensed at step 140 main fuel is injected at step 150 and the gas is scrubbed at a high temperature. At steps 140a, 150a, 160a, if the ignition flame due to the injection of the ignition fuel or the main flame due to the injection of the main fuel is not sensed, the injection of the fuel is stopped and bypassed at steps 140b, 150b and 160b.

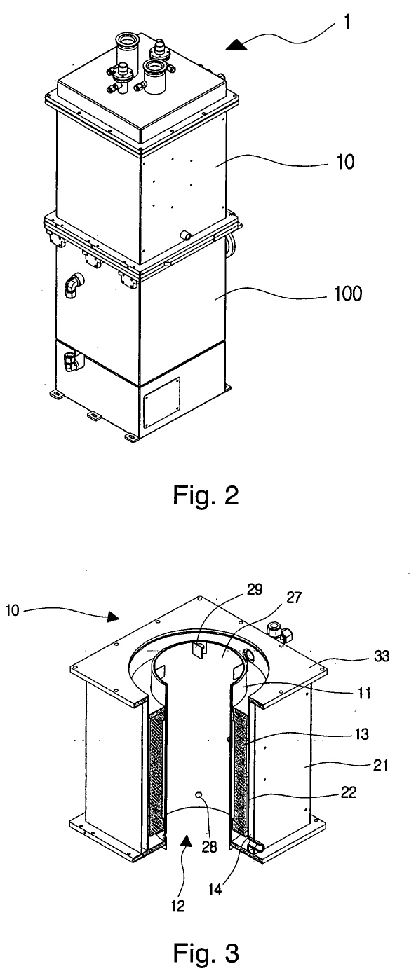

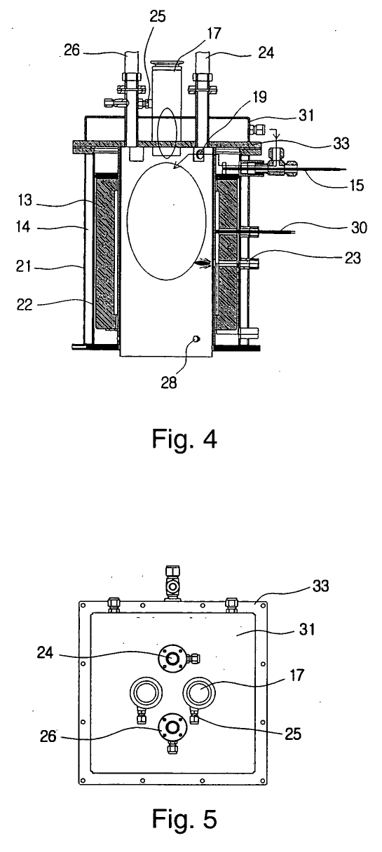

FIG. 2 is a perspective view of a gas scrubber according to an embodiment of the present invention. The gas scrubber is a mixed type gas scrubber where the burning method and the wetting method are combined. In other words, the gas scrubber 1 includes a burning chamber 10 and a wetting chamber 100 as shown in FIG. 2. However, the present invention is characterized by the burning chamber 10, and accordingly, a partial cutaway perspective view of a burning chamber, a sectional view, and a plane view are respectively shown in FIGS. 3-5.

As shown in the drawings, the burning chamber 10 has an inner casing 11 defining a waste gas burning room 12. The waste gas burning room has at least one gas inlet for introducing the waste gas thereinto and air inlet for introducing air thereinto.

An electrical heater 13 is disposed on an outer circumference of the inner casing 11, and is connected to an external power source (not shown) through a power supply line 15. Also, an adiabatic member 14 is disposed on an outer circumference of the electrical heater 13. An outer casing 21 is disposed at an outer portion of the burning chamber 10, and a middle casing 22 is disposed between the outer casing 21 and the inner casing 11 in a longitudinal direction to divide the space therebetween. Here, the electrical heater 13 is built in between the middle casing 22 and the inner casing 11, and the adiabatic member 14 is built in between the outer casing 21 and the middle casing 22.

That is to say the outer casing 21, the adiabatic member 14, the middle casing 22, the electrical heater 13 and the inner casing 11 are arranged in the burning chamber 10 in the order named from an outside.

By the above construction, the waste gas burning room 12 is heated by the electrical heater 13. At this time, the adiabatic member 14 prevents heat from being leaked from the waste gas burning room 12, thereby enhancing the heat efficiency of the electrical heater 13.

The inner casing 11 is provided with an ignition fuel port 23, a main fuel port 25 and an ignition sensor 24.

The ignition fuel port 23 disposed at a side portion of the inner casing 11 permits a small amount of injection of fuel such as LNG or LPG when the temperature of the waste gas burning room 12 rises above a predetermined temperature (i.e., ignition temperature), for example above about 600° C., by the electrical heater 13. The inner temperature of the waste gas burning room 12 may be sensed by a temperature measuring means 30 installed at a side portion of the burning chamber 10. The heating temperature by the electrical heater 13 can be set properly according to the components or scrubbing environment of the waste gas.

The ignition sensor 24 is disposed on the upper portion of the waste gas burning room 12 to sense flame due to the burning of a small amount of fuel injected through the ignition fuel port 23. the sensor 24 is an UV sensor preferably. However, Other sensors may be used instead.

When the ignition sensor 24 senses a flame, a large amount of fuel is injected through the main fuel port 25. Preferably, the main fuel port 25 is connected to and communicates with the gas inlet 17, which enables the waste gas to be mixed with the fuel before the waste gas is introduced into the waste gas burning room 12, thereby enhancing the burning efficiency.

A main flame sensor 26 for sensing a flame due to burning of main fuel is disposed on the waste gas burning room 12 so as to sense whether the main fuel is normally burnt due to the injection of the main fuel.

Thus, the inner temperature of the burning chamber 10 rises to a predetermined temperature by the electrical energy and then the fossil fuel is burnt to scrub the waste gas, so that a high efficiency in scrubbing the waste gas can be obtained despite usage of a small amount of fuel and it is also possible to decrease the emission of CO₂ gas. In addition, the structure is simplified and ignition is easy since a separate ignition source is not used.

A jacket 27 for preventing the inner casing 11 from being corroded is disposed on an inner surface of the inner casing 11. The jacket 27 is preferably made of nickel. The jacket 27 is fixed to the inner casing 11 by a fixing pin 28 for example, such that it is exchangeable. By doing so, the life cycle of the burning chamber 10 can be extended.

Preferably, at least one turbulence-forming wing 29 is formed at an upper end of the jacket 27. The turbulence-forming wing 29 can be formed by partially cutting away the jacket 27 and bending the cutaway portion at a predetermined angle. The wing 29 allows the waste gas and the fuel to form a turbulence, thereby accelerating a mixing of the waste gas and the fuel to enhance the burning efficiency.

In addition, a heat exchange jacket 31 is disposed at an upper end of the burning chamber 10 such that the high temperature heat of the waste gas burning room 12 is blocked and not transmitted to an upper portion of the UV sensors 24 and 26. Room temperature air introduced into the heat exchange jacket 31 absorbs the high temperature heat of the waste gas burning room 12 to prevent the high temperature heat of the waste gas burning room 12 from being directly transmitted. At this time, the heated air can be transmitted to the air inlet 19 and be used to burn the waste gas (see an arrow of FIG. 3). In other words, the heat exchange jacket 31 preheats air to be used in burning the waste gas, thereby enhancing the energy efficiency.

A gasket 33 is disposed between the upper end of the burning chamber 10 and the heat exchange jacket 31 to seal the waste gas burning room 12 such that air is not leaked.

Operation of the gas scrubber according to the embodiment of the present invention will now be described with reference to the accompanying drawings.

First, the electrical heater operates to heat the inside of the waste gas burning room 12 to a predetermined temperature. When the temperature measuring means 30 measures that the temperature of the waste gas burning room 12 reaches a set temperature, a small amount of fuel is injected through the ignition fuel port 23. As the ignition fuel is injected, an ignition flame is generated. At this time, the ignition flame UV sensor senses the flame. As the UV sensor transmits a flame sensing signal, a large amount of main fuel is supplied through the main fuel port, so that a main flame is formed. At this time, the main fuel is introduced into the waste gas burning room 12 mixed with the waste gas, and the main fuel and the waste gas are further uniformly mixed by the turbulence-forming wing. At the same time, room temperature air is preheated through the heat exchange jacket 31, is then supplied to the waste gas burning room 12, and is used for burning the waste gas. The main flame UV sensor senses that the main fuel flame is generated such that an operator confirms the progress of the burning.

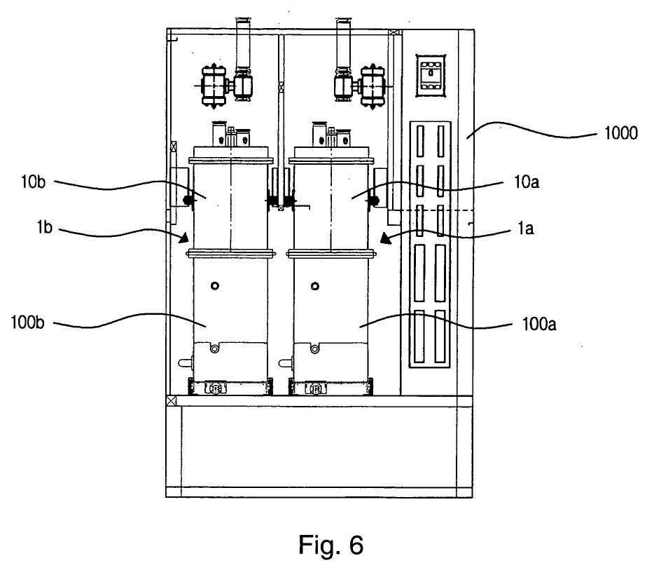

FIG. 6 is a front view of a gas scrubber according to another embodiment of the present invention. As shown, two gas scrubbers each having the burning chamber of the previous embodiment are installed in one housing. In the gas scrubber of FIG. 6, it is possible to continue the gas scrubbing operation even when a scrubber is stopped due to an operation failure.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for scrubbing a gas exhausted in a semiconductor manufacturing process, wherein electrical energy and fossil energy are both used and their usage rates are adjusted according to components contained in the gas and scrubbing environment.

2. A method for scrubbing a gas, the method comprising a stage of burning a gas exhausted in a semiconductor manufacturing process, wherein the burning stage comprises:
raising temperature of a burning chamber to above a predetermined temperature by an electrical heater;
when it is sensed that the temperature of the burning chamber is above the predetermined temperature, injecting a burning air and an ignition fuel to generate an ignition flame; and
when the ignition flame is sensed, injecting a main fuel with the gas to generate a main flame and burn the gas.

3. A gas scrubber provided with a burning chamber, the burning chamber comprising:
an inner casing defining a burning room;
at least one gas inlet for introducing the waste gas into the burning room;
an air inlet for introducing air into the burning room; and
an electrical heater disposed on an outer circumference of the burning room and connected to a power source through a power supply line, wherein the burning room comprises:
an ignition fuel port for introducing an ignition fuel into the burning chamber when the inner temperature of the burning room rises above a predetermined temperature;
an ignition sensor for a flame generated by injecting the ignition fuel, and
a main fuel port for supplying a large amount of fuel when the ignition sensor senses an ignition flame.

4. A gas scrubber of claim 3, further comprising an adiabatic member disposed on an outer circumference of the electrical heater.

5. A gas scrubber of claim 4, wherein an outer casing is outside the burning chamber, a middle casing is disposed between the outer casing and the inner casing for dividing the space therebetween, the electrical heater is disposed between the middle casing and the inner casing, and the adiabatic member is disposed between the outer casing and the middle casing.

6. A gas scrubber of claim 3, wherein a main flame sensor for sensing flame by the supplied main fuel is disposed in the burning room.

7. A gas scrubber of claim 3, wherein the main fuel port is connected to the gas inlet such that the waste gas is mixed with the fuel before being introduced into the burning room.

8. A gas scrubber of claim 3, wherein the inner casing is provided detachably on the inner surface with an anticorrosive jacket made of nickel.

9. A gas scrubber of claim 8, wherein the anticorrosive jacket has at least one turbulence-forming wing formed at the upper portion, the turbulence-forming wing being formed by partially cutting away the anticorrosive jacket and bending the cutaway portion at a predetermined angle so as to accelerate mixing between the waste gas introduced and the fuel due to the turbulence formed.

10. A gas scrubber of claim 3, wherein the burning chamber is provided at the upper portion with a heat exchange jacket such that the inner heat of the chamber is blocked and not transmitted to an upper portion of the sensor, wherein air that has passed through the heat exchange jacket is transmitted to the air inlet.

11. A gas scrubber of claim 10, further comprising a seal gasket disposed between an upper end of the burning chamber and the heat exchange jacket.

12. A gas scrubber of claim 3, wherein at least two scrubbers are installed in a housing.
